(19) United States
(12) Patent Application Publication
(10) Pub. No.: US 2026/0065127 A1
(43) Pub. Date: Mar. 5, 2026

(54) OVERLAPPING SUBSTAGE PARALLELISM FOR MACHINE LEARNING MODEL TRAINING

(71) Applicant: ADVANCED MICRO DEVICES, INC., Santa Clara, CA (US)

(72) Inventors: Sumanth Gudaparthi, Santa Clara, CA (US); Sonali Singh, Santa Clara, CA (US); Karthik Ramu Sangaiah, Bellevue, WA (US)

(21) Appl. No.: 18/817,817

(22) Filed: Aug. 28, 2024

(51) Int. Cl. G06N 20/00

(52) U.S. Cl. CPC G06N 20/00

(57) ABSTRACT

A processing system schedules training of a machine learning model based on identifying one or more substages of passes (e.g., backward passes) of microbatches associated with training the machine learning model. At least some of the identified substages for a given layer generate, during a pass, data used to train other layers of the machine learning model, while other substages only generate data used to train the given layer.

Accordingly, a scheduler of the processing system schedules the substages based on whether the data generated by the substage is used to train a different layer of the MLM.

### BACKGROUND

Machine learning models are used in a wide variety of applications, including natural language processing, language translation, image processing and identification, and many others. Prior to being employed for a given application, a machine learning model (MLM) is trained by applying a set of training data to the MLM, and adjusting parameters of the MLM, such as one or more sets of weights for one or more layers of the MLM, until the MLM achieves a satisfactory performance. In many cases, training an MLM consumes a relatively high amount of resources, including processing resources and training time. To improve training efficiency, some training systems train multiple instances of the same neural network model where the weights of each model are different from another. This approach is suitable for example, in training model ensembles (where the weights of the models in the ensemble are initialized differently, usually by using different random seeds, or using different training data), hyperparameter tuning, finetuning a pretrained model on multiple sub-domains, language translation from various source to destination languages, and sentiment models for different languages (e.g., English Sentiment model, French Sentiment model and so on). However, conventional approaches to multi-instance training generate a relatively large number of idle processing cycles, limiting training efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that schedules training of a machine learning model based on identifying substages of one or more passes associated with the machine learning model in accordance with some embodiments.

FIG. 2 is an example of the processing system of FIG. 1 identifying substages of one or more passes for training a machine learning model in accordance with some embodiments.

FIG. 3 is an example of the processing system of FIG. 1 scheduling training of a machine learning model based on identified substages of one or more passes of the machine learning model in accordance with some embodiments.

FIG. 4 is a flow diagram illustrating a method of training a machine learning model based on a number of micro-batches associated with the machine learning model in accordance with some embodiments in accordance with some embodiments.

### DETAILED DESCRIPTION

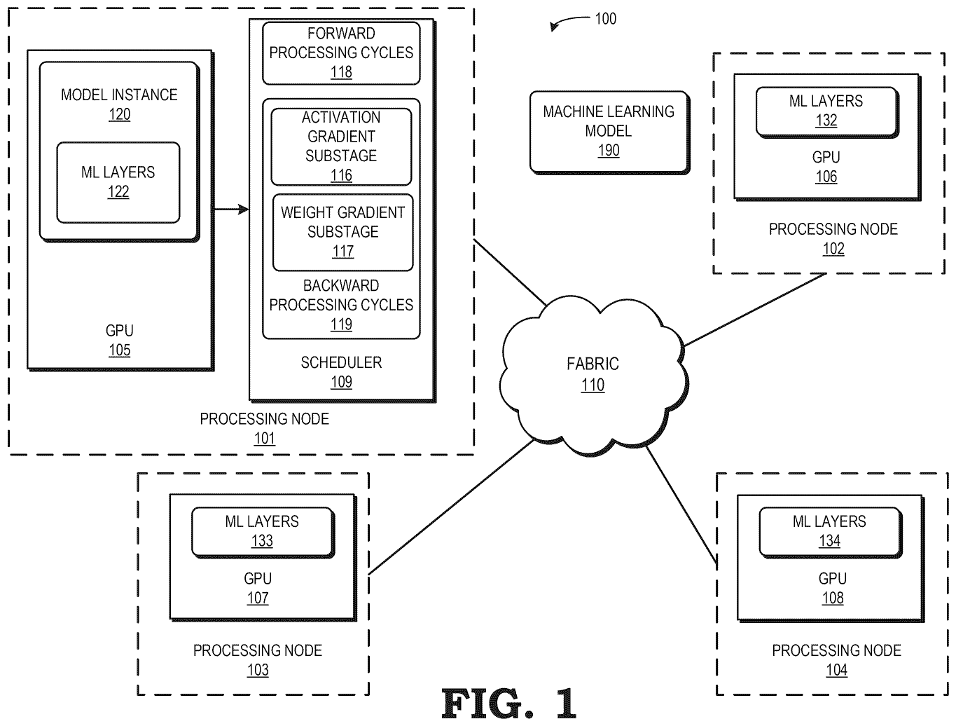

FIGS. 1-4 illustrate techniques for scheduling, at a processing system, training of a machine learning model based on identifying one or more substages of passes (e.g., backward passes) of microbatches associated with training the machine learning model. At least some of the identified substages for a given layer generate, during a pass, data used to train other layers of the machine learning model, while other substages only generate data used to train the given layer. Accordingly, a scheduler of the processing system schedules the substages based on whether the data generated by the substage is used to train a different layer of the MLM. The processing system thus reduces the number of idle cycles during training of the MLM, and thereby improves overall MLM training efficiency.

To illustrate, conventional MLM training systems employ multiple processing units (e.g., multiple graphics processing units (GPUs) to train an MLM. To increase the output throughput, an MLM training system employs distribution strategies such as data parallelism, and model parallelism. Pipeline parallelism is a prominent form of model parallelism technique that shares the layers of a machine learning model across multiple devices, thereby supporting (i) scalability, and (ii) addressing the insufficient memory capacity to encapsulate large models within a single processing unit. However, this parallelization strategy results in idle cycles wherein one or more of the processing units are waiting for one or more other processing units to complete a computation. For example, in a given training system, an MLM is distributed across four processing units. If the MLM has eight layers, then in this example each processing unit executes two different layers of the MLM during training. For training, the operations of the MLM are divided into a set of minibatches, wherein each minibatch is a different subset of the training samples. Each minibatch is split into multiple microbatches to allow for overlapping of individual microbatch execution. Thus, for example, if the MLM has a batch size of 8, the MLM is divided into eight microbatches each of size one. Layers one and two are executed at a first processing unit and layers three and four of the MLM are executed at a second processing unit. Thus, for proper training, a given microbatch must complete the first and second layers at the first processing unit before the second processing unit executes the third and fourth layers.

Furthermore, a conventional MLM training system typically executes at least two passes for each microbatch: a forward pass (also referred to as forward propagation) and a backward pass (also referred to as backpropagation). In addition, a conventional training system finishes the forward pass of all the layers and then starts the backward pass for all the layers in reverse order. For instance, if there are four layers, the system executes the forward passes in the order 1,2,3,4, and then executes the backward passes in the order 4,3,2,1. This results in one or more idle cycles at one or more of the processing units.

To reduce the number of idle cycles, using the techniques described herein, a scheduler identifies one or more substages of one or more passes for training the MLM, wherein the identified substages generate, during the corresponding pass, data used by another layer of the MLM. The other substages do not generate data used by another layer of the MLM during training. Accordingly, the scheduler schedules the passes, and substages of the passes, such that a substage of a layer is scheduled as soon as possible after the data needed by the layer is available to execute another substage. The scheduler thus improves overall training efficiency for the two MLM instances without impacting training performance.

To further illustrate via an example, in some embodiments, during a forward pass of a layer of an MLM, the output is computed by multiplying the inputs with the weights (parameter) of the layer as matrix multiply operations. In contrast, during the backward pass, there are two computations: computation of activation gradients and computation of weight gradients. Each of these computations is a substage of the backward pass. In addition, the number of computations for each of the gradient calculation (activation & weight) is the same as the number of computations employed to perform forward pass for the same layer. Since both the forward pass and the backward pass for a given layer are always computed on the same machine during pipeline parallelization, due to the nature of the additional computations, a backward pass takes twice as long as forward pass.

Furthermore, and as explained further below, the two substages in the backward pass are completely independent of each other, and only data from one of the substages (the activation gradient substage) is used by the next layer of the MLM for training.

Accordingly, rather than wait for both substages of the backward pass to complete, using the techniques herein the scheduler schedules the backward pass for the next layer to begin execution as soon as possible after the activation gradient substage for the layer is completed. The scheduler thus reduces the number of idle cycles at the processing system during training, and thus improves overall training efficiency.

FIG. 1 illustrates a processing system 100 that is generally configured to train a machine learning model neural network (referred to herein as a machine learning model, or MLM, 190 for simplicity) in accordance with some embodiments. In some embodiments, the MLM 190 is a transformer model such as a large language model (LLM). Accordingly, in various embodiments, the processing system 100 is part of any one of a number of electronic devices that employ an MLM, such as a server (or set of servers), a desktop computer, a laptop computer, a game console, a smartphone, and the like.

In at least some embodiments, the MLM 190 includes a plurality of layers that each perform specified operations based on a received input data (e.g., a token representing words, characters, or phrases, an input vector, or an input matrix) to generate output data, such as an output vector or output matrix. Examples of the layers in some embodiments include self-attention layers, normalization layers, gating functions, and experts. To illustrate, in some cases, when the MLM 190 (or an instance of the MLM 190) is executed, a self-attention layer of the MLM 190 receives an input token, either from another layer of the MLM 190 or as initial input token for the MLM 190. The self-attention layer performs one or more self-attention operations based on the input token and provides the result to a normalization layer, which normalizes the resulting token to generate an output token. The output token is provided to another layer of the MLM 190, or as an output of the model. Furthermore, in some embodiments the MLM 190 includes a plurality of one or more self-attention layers, normalization layers, gating functions, and experts chained together to collectively implement the model.

The processing system 100 is generally configured to train one or more instances of the MLM 190. As used herein, an instance of the MLM 190 refers to an MLM that has the same structure or architecture as the MLM 190 but has different weights than other instances of the MLM 190. In the example of FIG. 1, the processing system 100 is configured to train one instance of the MLM 190, designated model instance 120.

However, in other embodiments the processing system 100 is configured to train multiple different instances of the MLM 190, with each model instance having the same structure or architecture as the MLM 190 (and thus the same number of layers and interconnection between the nodes and layers of the MLM) but have different weights for one or more of the layers.

The processing system 100 is generally configured to train the model instance 120. To train a model instance, the processing system 100 applies a sets of training data to inputs of the model instance, propagates the inputs through the layers of the model instance, determines a set of errors for one or more of the layers based on an output of the layer or model instance and an expected output, and adjusts the weights of one or more layers of the model instance based on the set of errors.

In at least some embodiments, the processing system 100 trains a model instance by executing both a forward pass (also known as forward propagation) at each layer of the and a backward pass (also known as backward propagation). During the forward pass of a layer, inputs are provided to the layer (e.g., from another layer of the model instance), and the layer generates corresponding outputs based on the activation function and weights of the layer.

Furthermore, in some embodiments each backward pass has two different substages. As used herein, a substage of a pass refers to that calculates data used to adjust one or more weights or other parameters of an MLM during training that is independent of other substages of the pass (that is, a substage does not depend on data generated by a different substage of the same layer). The two substages of a backward pass include an activation gradient substage and a weight gradient substage.

The activation gradient substage of a backward pass, when executed, generates activation gradients according to the following formula:

$$dL / {dX}_{n} = {W}^{T} * ( dL / {dX}_{n + 1} )$$

where dL/dXₙ are the activation gradients for the nth layer, W is the weight matrix for the layer (and W^{T} is the transposed weight matrix for the layer), and dL/dXₙ₊₁ are the activation gradients for the next layer of the model (the nth+1 layer). The weight gradient substage of the backward pass, when executed, generates weight gradients according to the following formula:

$$dL / {dW}_{n} = ( dL / {dX}_{n + 1} ) * {X}_{n}^{T}$$

where dL/dWₙ are the weight gradients, and Xₙ is the input matrix for the layer (and Xₙ^{T} is the transposed input matrix).

To execute the operations for training the model instance 120, the processing system 100 includes a plurality of processing nodes, designated processing nodes 101-104. It will be appreciated that, in different embodiments, the processing system 100 includes fewer or more processing nodes than are illustrated at FIG. 1. The processing nodes 101-104 are all connected to a communication fabric 110 that is generally configured to communicate data (e.g., messages, packets, or other units of information) between the processing nodes. Accordingly, in different embodiments the communication fabric is an internal processor fabric, such as a Peripheral Component Interconnect Express (PCIe) fabric, a network fabric (e.g., one or more of a local area network and a wide area network (e.g., the Internet), a server interconnect, and the like, or any combination thereof.

Each of the processing nodes includes a set of processing circuitry, as well as supporting circuitry, to execute at least a portion of one or more layers of the MLM 190. In particular, each of the processing nodes 101 includes at least one processing unit, designated processing units 105-108 respectively. The processing units 105-108 are generally configured to execute operations to implement one or more layers (e.g., self-attention layers, normalization layers, gating functions, and experts) of the MLM 190.

The processing units 105-108 thus include sets of processing elements (e.g., compute units, single-instruction multiple-data (SIMD) units, processor cores, command processors, and the like, or any combination thereof), along with supporting circuitry (caches, schedulers, command buffers, and the like) that collectively execute the sets of operations corresponding to the transformer model layers. For purposes of description, it is assumed that the processing units 105-108 are graphics processing units (GPUs).

However, in other embodiments the processing units are any type of parallel processor, such as vector processors, general-purpose GPUs (GPGPUs), non-scalar processors, highly-parallel processors, artificial intelligence (AI) processors, inference engines, machine learning processors, other multithreaded processing units, and the like.

In at least some embodiments, the processing nodes 101-104 include additional circuitry not illustrated at FIG. 1. For example, in some embodiments one or more of the processing nodes 101-104 includes a central processing unit (CPU) generally configured to control the operations at one or more of the processing units 105-108 via, for example, the generation of one or more commands that instigate operations at the corresponding processing units. In addition, in some embodiments each of the processing nodes 101-104 includes one or more memory devices (e.g., dynamic random-access memory (DRAM) devices) that are configured to store data on behalf of the processing units, such as weights for one or more layers of the MLM 190.

Each of the processing nodes 101-104 also includes a scheduler generally configured to schedule operations, such as MLM training operations, at the corresponding processing unit. For example, the processing node 101 includes a scheduler 109 (the schedulers are not illustrated for processing nodes 102-104 for clarity). To increase training efficiency, the schedulers are generally configured to divide the training operations for the model instance 120 across the processing nodes 101-104, so that the processing nodes 101-104 execute at least some of the training operations in parallel. Thus, the schedulers are generally configured to collectively identify the layers of model instance 120 to be executed at each processing node, such that layers 122 are executed at processing node 101, layers 132 are executed at processing node 102, layers 133 are executed at processing node 103, and layers 134 are executed at processing node 104. The schedulers are further configured to divide the training operations for each layer into a set of minibatches, and to divide each minibatch into a corresponding set of microbatches. The schedulers then schedule execution of each microbatch at corresponding ones of the processing nodes 101-104, so that the microbatches of each layer are executed at the corresponding processing nodes.

For example, in some embodiments the MLM 190 includes eight layers and has a batch size of eight. The schedulers of the processing nodes 101-104 distribute the eight layers of the model instance 120 so that each of the GPUs 105-108 is assigned two different layers of a model instance. In addition, the schedulers divide each batch of the model instance into minibatches, and further divide the minibatches into microbatches.

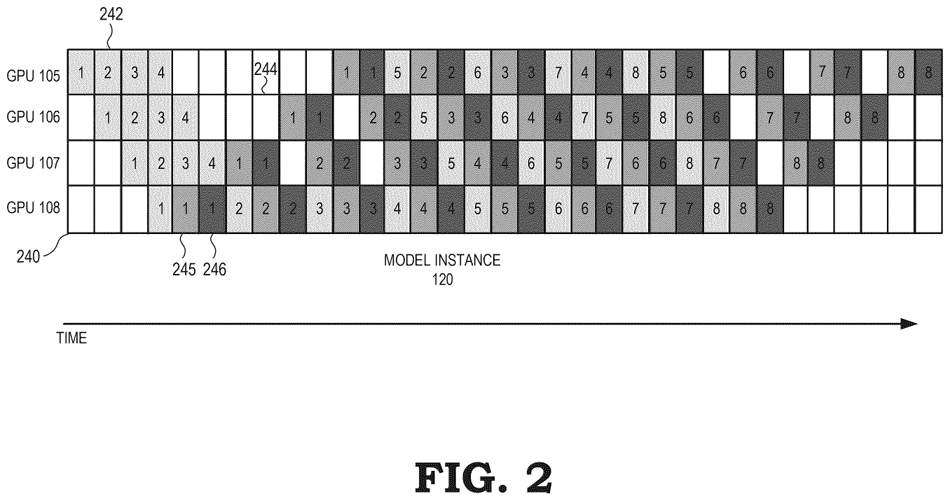

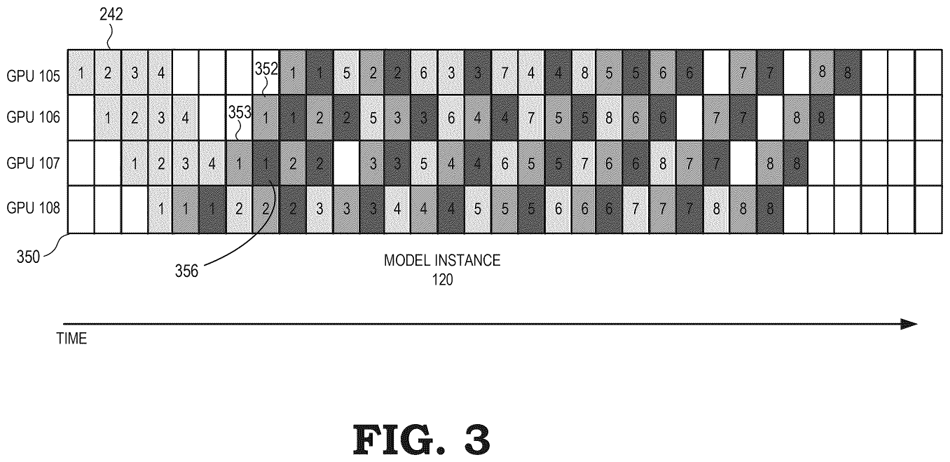

The schedulers then assign each microbatch to a corresponding one of the GPUs 105-108 for execution. This allows the microbatches to be scheduled so that at least some of the microbatches are executed in parallel, as described further below with respect to FIGS. 2 and 3.

As noted above, to train the model instance 120, for each microbatch, the GPUs 105-108 execute a forward pass and a backward pass. Under conventional training techniques, the model instance 120, a processing system completes both the forward pass and the full backward pass for a microbatch before executing the backward pass for the next microbatch in the schedule (that is, for the next microbatch having a backward pass that depends on data generated by a given microbatch). This can be better understood with reference to FIG. 2, which illustrates a schedule 240 in accordance with some embodiments. The schedule 240 corresponds to a specified initial training schedule for the model instance 120.

In the illustrated example, the schedule 240 has four rows and thirty-three columns, wherein each row corresponds to a different one of the GPUs 105-108, and each of the columns corresponds to a processing cycle of the corresponding GPU that are used to execute a microbatch at the GPU. For simplicity, it is assumed for the example of FIGS. 2 and 3 that each column corresponding to one processing cycle, but it will be appreciated that in other embodiments each column represents multiple processing cycles, with each column representing the same number of processing cycles. A numbered entry in a schedule indicates the microbatch being processed at the corresponding GPU during the corresponding processing cycle. A blank entry indicates that the corresponding GPU is idle during the corresponding processing cycle.

Furthermore, a lighter shading of an entry indicates a forward pass for the corresponding model instance, and darker shading of entries indicate indicates a backward pass for the corresponding model instance. In addition, the entries corresponding to backward passes have different shading to indicate the different substages of each backward pass, where relatively lighter shading of a backward pass indicates an activation gradient substage and darker shading of a backward pass indicates a weight gradient substage.

Thus, in the example of FIG. 2, the entry 242 indicates that a forward pass for microbatch 2 is scheduled to be executed at GPU 105 during the corresponding processing cycle. The entry 244 indicates that an idle cycle is scheduled for GPU 106 during the corresponding processing cycle. The entry 245 indicates that an activation gradient substage of a backward pass for microbatch 1 is scheduled for execution at GPU 108 during the corresponding processing cycle. The following entry 246 indicates that a weight gradient substage of a backward pass for microbatch 1 is scheduled for execution at GPU 108 during the corresponding processing cycle.

In the illustrated example, at least some training operations are concurrently scheduled for a given model instance. Thus, for example, the schedule 240 initiates execution of a forward pass microbatch 1 at the GPU 105. Upon completion of execution of microbatch 1 (that is, upon executing a forward pass at the layers of model instance 120 assigned to GPU 105), the GPU 105 provides the resulting outputs to GPU 106.

During the next processing cycle, the GPU 106 uses the data provided by GPU 105 to execute a forward pass of the layers 132 of the model instance 120 assigned to the GPU 106 and provides the resulting output data to the GPU 107. In addition, during the same processing cycle, the GPU 105 initiates execution of microbatch 2. Thus, under the schedule 240, once the input data is available for a GPU to execute a corresponding microbatch (because, for example, another GPU has completed generating the input data), the GPU executes the microbatch. Because the layers are distributed among the GPUs 105-108, different GPUs execute different microbatches, at the corresponding layers, in parallel. However, as shown in the example of FIG. 2, there are some processing cycles wherein the input data for a particular backward or forward pass has either not been generated or not yet made available to the next GPU for processing, and the corresponding GPU is therefore idle for one or more processing cycles as it awaits generation of the input data. For example, entry 244 shows that an idle cycle occurs at the GPU 105 because the input data to execute a backward pass of microbatch 6 has not yet been made available to the GPU 106.

To reduce the number of idle cycles at the GPUs 105-108, the scheduler 109 is configured to schedule at least one substage of a backward pass as soon as possible after the input data used by the at least one substage has been generated, even if the other substage of the backward pass has not yet been executed. In particular, as noted above, a backward pass at a given layer of the MLM 190 only uses the activation gradients from the next layer, and does not use the weight gradients. Accordingly, the scheduler 109 is configured to schedule at least one activation gradient substage of a backward pass for a layer of MLM 190 after the activation gradient substage for the next layer has generated the corresponding activation gradients, and prior to completion of the corresponding weight gradient substage. An example is illustrated at FIG. 3 in accordance with some embodiments.

FIG. 3 illustrates a schedule 350, having entries and shading corresponding to that described above with respect to FIG. 2. However, in the example of FIG. 3, the scheduler 109 has generated the schedule 350 so that one or more backward passes for a microbatch at an Nth layer of the MLM 190 (or substages of one or more backward passes) are scheduled after the Nth+1 layer of the MLM 190 completes execution of the activation gradient substage for the corresponding microbatch.

Thus, for example, entry 353 indicates execution of the activation gradient substage for microbatch 1 at the layers of the model instance 120 assigned to GPU 107. For this example, the layers at the model instance 120 correspond to the Nth+1 layer.

The scheduler 109 has scheduled the activation gradient substage for microbatch 1 at the Nth layer (at GPU 106) during the next processing cycle, as indicated by entry 352.

Thus, the scheduler 109 has scheduled the activation gradient substage for microbatch 1 at the Nth layer to be executed in parallel with the weight gradient substage for microbatch 1 at the Nth+1 layer, as shown by entry 356. That is, the scheduler 109 schedules the activation gradient substage for microbatch 1 at the Nth layer of the model instance 120 to initiate execution prior to completion of execution of the weight gradient substage for microbatch 1 at the Nth+1 layer.

Because the results of the weight gradient substage at the Nth+1 layer do not impact the execution or results of the backpass at the Nth layer, scheduling the backpass substages in this way does not affect the results of training the model instance 120.

However, scheduling the backpass substages in this way reduces the number of idle cycles during training, as compared to the schedule 240 of FIG. 2. For example, entry 352 of the schedule 350 corresponds to entry 244 of the schedule 240. That is, the entries 352 and 242 correspond to the same processing cycle in the schedules 350 and 240, respectively. However, entry 352 indicates an activation gradient substage for microbatch 1 is executed at the GPU 106, while entry 242 indicates an idle cycle for the GPU 106. Thus, the schedule 350 has eliminated the idle cycle reflected by entry 242 of schedule 240.

After generating the schedule 350, the scheduler 109 provides commands to the GPUs 105-108 to execute the microbatches of the model instance 120 according to the schedule. In response, the GPUs 105-108 execute the microbatches in the sequence indicated by the schedule 350. Thus, the processing system 100 executes training operations for the model instance 120 with relatively few idle cycles, thus improving overall training efficiency of the model instance.

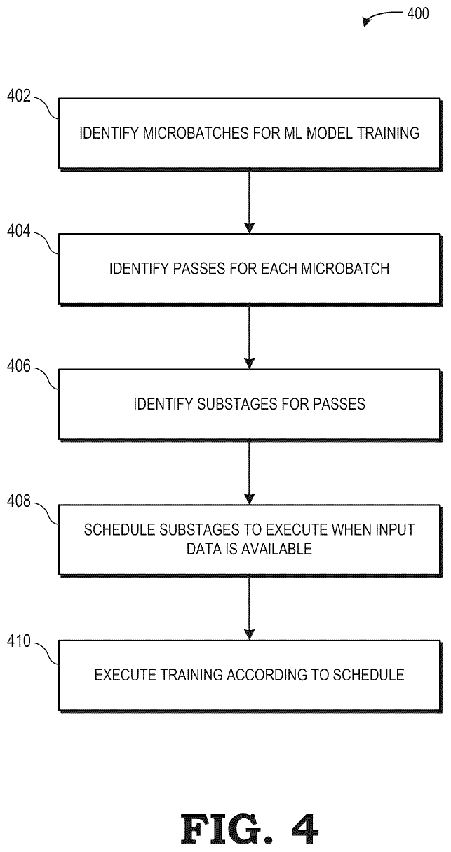

FIG. 4 illustrates a flow diagram of a method 400 of training a model instance in parallel at a processing system in accordance with some embodiments. For purposes of description, the method 400 is described with respect to an example implementation at the processing system 100 of FIG. 1, but it will be appreciated that in other embodiments the method 400 is implemented at processing systems having different configurations. At block 402, the scheduler 109 identifies a number of microbatches for training the model instance 120. For example, in some embodiments the scheduler 109 determines, based on the structure or architecture of MLM 190 an initial schedule that indicates the number of microbatches that will be employed to train each instance of the MLM 190.

At block 404 the scheduler 109 identifies, based on the initial schedule, the forward passes and backward passes that are to be executed to train the model instance 120. At block 406 the scheduler identifies, again based on the initial schedule, the substages for one or more of the passes identified at block 404. In some embodiments, the schedule 109 identifies an activation gradient substage and a weight gradient substage for each backward pass. For each activation gradient substage, the backward pass generates a set of activation gradients. Similarly for each weight gradient substage, the backward pass generates a set of weight gradients.

At block 408, the scheduler 109 schedules the identified passes and substages based at least in part on when the data used by a given pass or substage is available, even if a corresponding pass or substage has not yet been completed. Thus, for example, the scheduler 109 schedules a substage of a backpass based on data for that substage being available, because a corresponding substage that generates the data having completed.

At block 410, the scheduler 109 sends commands to the GPUs 105-108 to execute microbatches of the different model instances according to the schedule generated at block 408. In response, the GPUs 105-108 execute the microbatches according to the schedule, thereby training the model instance 120.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
executing a first pass for a first microbatch of a machine learning model (MLM) by executing a first substage and a second substage of the first pass; and
after executing the first substage of the first pass and prior to executing the second substage of the first pass, initiating execution of a first pass for a second microbatch of the MLM.

2. The method of claim 1, wherein the first pass of the first microbatch comprises a backward pass of the first microbatch.

3. The method of claim 1, wherein the first pass of the second microbatch uses results of the first substage of the first pass of the first microbatch.

4. The method of claim 1, wherein executing the first substage comprises calculating a first gradient calculation for the first microbatch.

5. The method of claim 3, wherein executing the second substage comprises calculating a second gradient calculation for the first microbatch.

6. The method of claim 4, wherein the first gradient calculation comprises an activation gradient for the first microbatch.

7. The method of claim 5, wherein the second gradient calculation comprises a weight gradient for the first microbatch.

8. The method of claim 1, further comprising:
executing the first pass for the second microbatch of a machine learning model executing a first substage and a second substage of the first pass for the second microbatch; and
after executing the first substage of the first pass for the second microbatch and prior to executing the second substage of the first pass, initiating execution of a first pass for a third microbatch of the MLM.

9. A method comprising:
scheduling a first pass for a first microbatch of a machine learning model (MLM) for execution, wherein scheduling the first pass comprises scheduling execution of a first substage and a second substage of the first pass at a first processing unit; and
scheduling a first pass for a second microbatch of the MLM at a second processing unit, wherein scheduling the first pass for the second microbatch comprises scheduling a first substage of the first pass for the second microbatch after the first substage of the first pass and prior to the second substage of the first pass.

10. The method of claim 9, wherein the first pass of the first microbatch comprises a backward pass of the first microbatch.

11. The method of claim 9, wherein the first pass of the second microbatch uses results of the first substage of the first pass of the first microbatch.

12. The method of claim 9, wherein the first substage comprises a stage to calculate a first gradient calculation for the first microbatch.

13. The method of claim 12, wherein the second substage comprises a stage to calculate a second gradient calculation for the first microbatch.

14. The method of claim 13, wherein the first gradient calculation comprises an activation gradient for the first microbatch.

15. The method of claim 14, wherein the second gradient calculation comprises a weight gradient for the first microbatch.

16. A processing system comprising
a plurality of processing units including a first processing unit and a second processing unit; and
a scheduler configured to:
schedule a first pass for a first microbatch of a machine learning model (MLM) for execution, wherein scheduling the first pass comprises scheduling execution of a first substage and a second substage of the first pass at the first processing unit; and
schedule a first pass for a second microbatch of the MLM at the second processing unit, wherein scheduling the first pass for the second microbatch comprises scheduling a first substage of the first pass for the second microbatch after the first substage of the first pass and prior to the second substage of the first pass.

17. The processing system of claim 16, wherein the first pass of the first microbatch comprises a backward pass of the first microbatch.

18. The processing system of claim 16, wherein the first pass of the second microbatch uses results of the first substage of the first pass of the first microbatch.

19. The processing system of claim 16, wherein the first substage comprises a stage to calculate a first gradient calculation for the first microbatch.

20. The processing system of claim 19, wherein the second substage comprises a stage to calculate a second gradient calculation for the first microbatch.
